(19) United States
(12) Patent Application Publication
(10) Pub. No.: US 2004/0125781 A1
(43) Pub. Date: Jul. 1, 2004

(54) Method and system for managing local control of WLAN access

(75) Inventors: Theodore W. Walter, Long Beach, CA (US); S. Robert Pye, Roswell, GA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Telemac Corporation, Los Angeles, CA

(21) Appl. No.: 10/672,281

(22) Filed: Sep. 25, 2003

Related U.S. Application Data
(60) Provisional application No. 60/413,509, filed on Sep. 25, 2002.

(51) Int. Cl. H04Q 7/24

(52) U.S. Cl. 370/338; 709/223

(57) ABSTRACT

A system for managing local control of WLAN access to a computer network is provided. The system includes an access point having access control software. The access control software is configured to allow the access point to meter and/or rate a communication session or connection. The metering and/or rating of the communication session or connection is determined based on certain specified business rules and/or usage parameters. The specified business rules and/or usage parameters are provided by an operator of the system.

### CROSS-REFERENCES TO RELATED APPLICATION

The present application claims the benefit of priority under 35 U.S.C. § 119 from U.S. Provisional Patent Application Serial No. 60/413,509, entitled “METHOD AND SYSTEM FOR MANAGING LOCAL CONTROL OF WLAN ACCESS”, filed on Sep. 25, 2002, the disclosure of which is hereby incorporated by reference in its entirety for all purposes.

### BACKGROUND OF THE INVENTION

The present invention generally relates to network access and, more specifically, to managing WLAN access using access point and communication equipment (such as routers).

Under conventional practice, the methods for controlling access to networks through WLAN connections have relied on the centralized billing functions of service providers (e.g., Boingo, Joltage). Customers of such providers typically pay for access to the network on a subscription basis, whether by the month or the day and with or without usage limitations. Customer accounts are maintained on the service provider's centralized database. That portion of the network that responds to an authentication challenge (e.g., a RADIUS server) is maintained with the identification information of customers whose accounts have met the service provider's payment requirements, whether for prepayment or payment in arrears within a certain time period. Even service providers that provide ad hoc access, such as a single day's access from an airport, rely on centralized billing and settlement systems and batch updates to their authentication database.

At the present time, location owners that wish to provide WLAN access to networks in order to attract customers (e.g. cafes) have limited ways in which to obtain a return on their investment in access point and communication equipment (such as routers). For example, they can provide access at no charge in hopes that such free access will generate an improvement in other areas of their business and provide a return on their investment. Alternatively, they can become a location provider for existing service provider(s) (e.g. Joltage). The benefit to their customers is then limited to those customers willing to subscribe with the service provider(s) and the return on investment is limited to the service provider's program for sharing its subscription revenue.

One factor that hinders location owners in their ability to obtain a return on their investment in access point and communication equipment is the lack of ability to provide selective control over access with respect to such equipment. Furthermore, such equipment also generally lacks the capability to allow a location owner or operator to exercise selective control over access based on a business model determined by the location owner.

Hence, it would be desirable to provide a method and system that is capable of providing selective control over access in access point and communication equipment and allowing such equipment to provide such selective control in accordance with a business model determined by the location owner.

### BRIEF SUMMARY OF THE INVENTION

According to one exemplary embodiment of the present invention, a local WLAN access point (such as a combined access point and router) is used to provide local control of access to a network, based on real-time metering and/or rating of one or more communication sessions. When real-time metering and/or rating of a communication session indicates that usage has exceeded an applicable usage limit, the access point has the ability to disconnect the WLAN connection thereby terminating access to the network of that user's communication session.

According to one exemplary implementation, access control software is used to facilitate local control of access to the network. The access control software resides in the access point and operates with other software of the access point, such as the access point operating system. The access control software is dormant until a location owner or operator of the access point chooses to activate it.

In an exemplary embodiment, the access control software provides various functions to facilitate local control of access to the network. The access control software interacts with the access point operating system to prompt a user (e.g., a HTML or telnet prompt) attempting to obtain access to enter an access code on his/her wireless device. The user may obtain the access code from a number of different sources including, for example, the location owner's personnel or from a display or printout from equipment at the location, which may include the access point, or the location's point of sale (POS) system or bank transaction system.

The access code includes a variety of information that may be used by the access point to control access by the user, including, information on the amount of usage permitted and/or other parameters permitting or limiting usage. Access codes may be generated by the access control software in the access point or may be generated by a remote control server and communicated to the location owner or equipment at the location. Alternatively, the access point may be designed to accept cash, like a vending machine, or debit or credit card information.

The access control software also interacts with the access point operating system to obtain real-time metering (or to facilitate such metering by external access control software) of one or more connections. Metering may be based on one or more of a number of criteria, including for example, per connection, duration of connection, or volume of data uploaded or downloaded using the connection.

The access control software may also provide real-time rating of the usage based on one or more criteria. For example, rating allows a communication session to be monitored with respect to dollar amounts used, where the usage limit is stated as a dollar amount. The usage limit can be measured using other types of criteria.

The access control software further interacts with the access point operating system to disconnect a communication session or connection that, based on the real-time metering and/or rating, has exceeded some usage limit.

The access control software allows a location owner or operator to specify and conform the use of the access point based on his/her specified usage parameters and/or business rules. Examples of usage parameters and/or business rules that a location owner is able to specify include: (a) maximum session time (e.g., in time or monetary units); (b) maximum data (up and/or down) (e.g., in bytes or monetary units); (c) pop-ups, warnings, and grace periods; (d) comps (e.g., free access with purchase); (e) varying rates by time of day, day of week (e.g., charge more during rush hour); (f) limiting access to a specific time of day, day of week, or to multiple time periods; (g) specifying certain free sites (i.e. use connected to these sites does not count toward usage limit) or alternatively, metering and rating a communication session based on the website being visited; (h) limiting the number of simultaneous users on-line; and (i) creating machine identification numbers for permitted users.

In one exemplary embodiment, the method of entering the usage parameters and/or the business rules into the access point involves entering the parameters on a keypad that is part of, or connected to, the access point. In the alternative, the parameters could be entered using a keypad that is part of, or connected to, a wireless device in secure communication with the access point. The parameters could also be entered using a device that is connected via the Internet to a server, which would in turn download the parameters to the access point via the Internet. The application software for entering the parameters steps the location owner through data entry thereby allowing the location owner to specify the desired usage parameters and/or business rules.

In one exemplary embodiment, the method of generating the access codes for the location owner involves a control server that is capable of communicating with the access point via the Internet or a computer network. The generation of access codes may be conditioned on the payment of a monthly amount by the location owner, for example, a combination of a maintenance and license fee. In this situation, the control server is able to deactivate the access control software in the access point for lack of payment. The generation of access codes may be based on the specified business rules and/or usage parameters of the location owner for whom the access codes are generated. Information regarding the parameters on the usage permitted, rating for usage, and/or other parameters permitting or limiting usage may be embedded in the access code.

The method of communicating the access codes to the location owner may involve downloading the access codes from the control server to the access point via a secure Internet connection or to a POS terminal at the location using a secure network, such as, a banking network.

The control server may also gather usage data and provides reports of that data to the location owner.

In an alternative exemplary embodiment, the access point or an associated device is configured to accept cash or other form of payment, such as debit or credit card information. The access point would then permit the amount of use associated with the payment made.

In another alternative exemplary embodiment, rather than an access code, the location owner could read the device ID from the device attempting to make a connection via the access point and the location owner could then enter into the access point the device ID with a product code for the amount of usage purchased.

Furthermore, the access point can be set up to look to a server residing on a network for authentication and to accommodate the user who may be a subscriber to an available service provider. If the authentication challenge fails at the server, the access control software can send a message to the user regarding the option to purchase access from the location owner and prompting for entry of an access code for authentication at the access point. Once the user purchases access from the location owner, s/he will have an access code to enter for the authentication challenge at the access point or otherwise have access permitted by the access point.

The present invention provides a number of benefits and/or advantages. For example, a benefit of the present invention is that it provides maximum flexibility to the location owner to provide, price, and obtain payment for the network access it provides to its customers via its access point. The location owner controls the business rules and/or usage parameters used to permit access to the network, meters and/or rates the usage in real-time, and, when appropriate, disconnects the user that has exceeded some limit on usage (e.g. a prepaid amount, credit limit, time limit, data limit). The location owner can provide, and charge for, access to the network to any customer, not just subscribers of certain service provider(s). The user is able to pay for the use s/he intends, rather than having to pay a flat subscription rate that is not related to that customer's intended usage.

Reference to the remaining portions of the specification, including the drawings and claims, will realize other features and advantages of the present invention. Further features and advantages of the present invention, as well as the structure and operation of various embodiments of the present invention, are described in detail below with respect to accompanying drawings, like reference numbers indicate identical or functionally similar elements.

### BRIEF DESCRIPTION OF THE DRAWINGS

FIG. 1 is a simplified block diagram illustrating an exemplary embodiment of the present invention; and

FIG. 2 is a simplified block diagram illustrating another exemplary embodiment of the present invention with a control server.

### DETAILED DESCRIPTION OF THE INVENTION

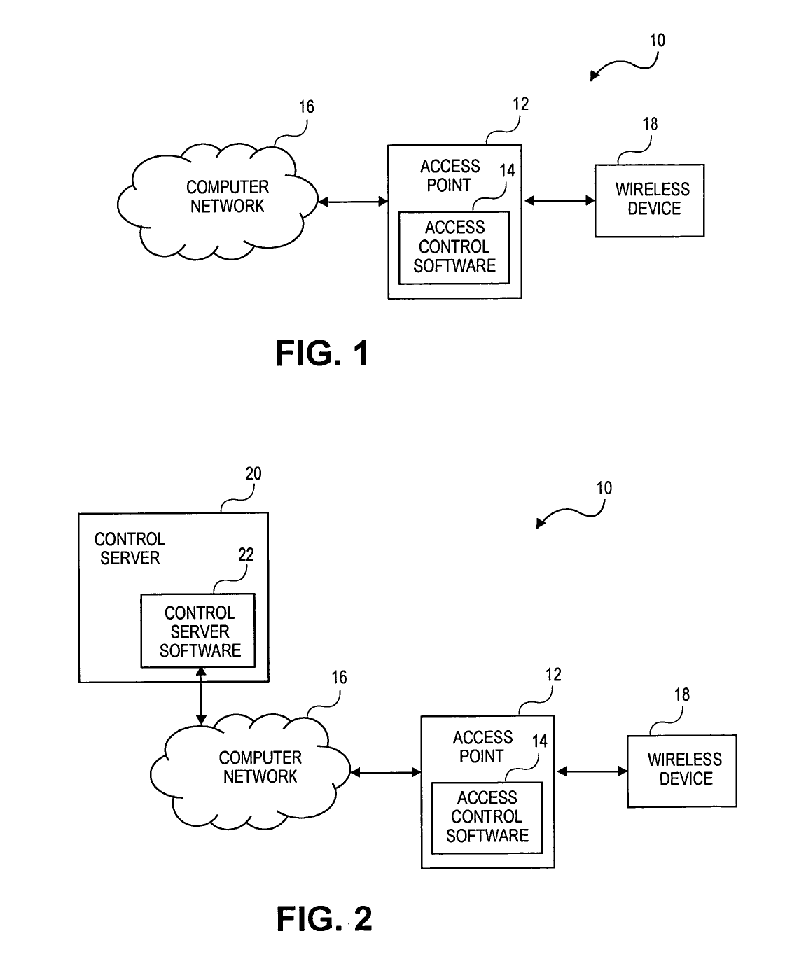

The present invention in the form of one or more exemplary embodiments will now be described. FIG. 1 is a simplified block diagram illustrating an exemplary embodiment of the present invention. Referring to FIG. 1, the exemplary embodiment includes a system 10 having an access point 12 with access control software or logic 14 residing thereon. In one exemplary implementation, the access point 12 is a WLAN (wireless local area network) access point router and the access control software 14 is an 802.1x extensible authentication protocol (EAP) application developed based on the WLAN standard. Other exemplary implementations include Bluetooth™ or other short range radio communication protocols. Based on the disclosure and teachings provided herein, a person of ordinary skill in the art will appreciate other communication protocols that can be used to implement the present invention. When active, the access control software 14 provides a number of functions to allow the access point 12 to act as, for example, a built-in authentication, authorization, and accounting (AAA) server, as will be further described below.

In the exemplary embodiment as shown in FIG. 1, the access control software 14 provides a number of functionality. For example, the access control software 14 may be activated by the location owner (“operator”) of the access point 12 during system initialization (or at a later time). If not activated, the access control software 14 remains entirely inactive.

When activated, the access control software 14 receives an access code (or other payment information) from each wireless client or device 18 attempting to contact the access point 12 to establish access to the computer network 16. Unless the access code is valid, the access control software 14 will not authenticate the wireless client 18 thereby preventing the wireless client 18 from establishing access via the access point 12.

Following a valid access attempt, the access control software 14 may display a legal conditions window and seek positive acknowledgement before allowing a communication session to be established with the computer network.

The access control software 14 is able to (a) test access codes for validity, and (b) interpret access codes into a quantifiable amount of service to be provided based on the operator's business rules.

For each client 18 presenting a valid access code, the access control software 14 establishes a temporary individual account. Each account includes a certain amount of permitted usage based on the access code.

The access control software 14, operating in conjunction with other software or applications on the access point 12, such as, the access point operating system software, is able to simultaneously monitor various communication sessions corresponding to different temporary individual accounts. As the client 18 engages in a communication session using the connection established via the access point 12, the access control software 14 continually monitors the remaining usage permitted in his/her temporary account in real time.

Based on operator-defined parameters (i.e. the location owner's business rules), the access control software 14 may direct a warning to the client 18 (e.g., a pop-up window on the client's wireless device) when the usage approaches the allowable usage limit or threshold. Similarly, this capability could also be used as an advertising medium, similar to an Internet pop-up window, appearing, for example, every five minutes.

When usage exceeds the allowable usage limit, the access control software 14 is capable of instructing the access point 12 to terminate (or disassociate) the communication session with the client 18 immediately.

Furthermore, the access control software 14 may also provide the following functionality. For example, the access control software 14 is capable of allowing the operator to define the usage parameters and/or business rules governing usage and access conditions. This capability is user-friendly and associated with extensive, well-organized help functions. The usage parameters and/or business rules are stored in the access point 12 and are used to direct the access control software 14 on how to meter and/or rate the communication sessions or connections established via the access point 12 and how to interpret access codes. One or more methods may be available to meter and/or rate a communication session. It should be understood that, in some instances, a method may be used to both meter and rate a communication session; in other instances, a first method may be used to meter and a second method may be used to rate a communication session. Using the information associated with an access code, the access control software 14 is able select the appropriate method(s) to meter and rate a corresponding communication session. The operator is given the flexibility to define usage parameters and/or business rules based on a number of criteria including, for example, (a) maximum session time (e.g., in time or monetary units); (b) maximum data (up and/or down) (e.g., in bytes or monetary units); (c) pop-ups, warnings, and grace periods; (d) comps (e.g., free access with purchase); (e) varying rates by time of day, day of week (e.g., charge more during rush hour); (f) limiting access to a specific time of day, day of week, or to multiple time periods; and (g) specifying certain free sites (i.e. use connected to these sites does not count toward usage limit); (h) limiting the number of simultaneous users or clients on-line; and (i) creating machine identification numbers for permitted users. The access control software 14 is capable of generating access codes based on the specified usage parameters and/or business rules.

FIG. 2 is a simplified block diagram illustrating another exemplary embodiment of the present invention. In this exemplary embodiment, the access control software 14 works in cooperation with a control server 20 with control server software 22 residing there on. The control server software 20 enables a number of optional functions such as, for example, payment for the end user and billing, reporting, roaming, and security for the operator.

In the exemplary embodiment as shown in FIG. 2, the access control software 14 may provide the following additional functionality. For example, when initially activated, the access control software 14 directs the operator, via the Internet, to an account initialization function provided by the control server software 22. The account initialization function prompts the operator through the process of establishing an account at the control server 20. The access control software 14 is capable of receiving access codes, as well as, usage parameters and/or business rules from the control server software 22.

In the exemplary embodiment as shown in FIG. 2, the control server software 22 is capable of performing the following functions. For example, the control server software 22 is capable of handling communications with a number of access points 12. The control server software 22 is capable of directing a new operator through the process of establishing a new account. This process may be entirely automated, although a help function may also be provided. The account is set up so that the control server 20 can monitor and keep track of activities relating to the corresponding access point 12.

The new account process may include, for example, (a) collecting identification and address information, including e-mail validation; (b) performing credit check as required (alternatively, this function may be passed to an interested party system); (c) selecting billing methods (examples might include a prepaid account, such as, PayPal, or credit card, with an extra-cost option for paper bill); (d) displaying terms disclosure and legal agreements; and (e) stepping the operator through usage parameters and/or business rules set-up.

Once an account is set up for the access point 12, the access point 12 can issue requests to the control server 20 for access codes. The control server software 22 is capable of generating access codes based on the specified usage parameters and/or business rules provided by the operator of the access point 12. The access code allows the access control software 14 to authenticate the client 18 based on a proprietary algorithm shared between the access control software 14 and the control server software 22.

The control server software 22 is capable of communicating access codes, as well as, usage parameters and/or business rules to the access control software 14. The control server 20 may be able to receive “product” information from the operator and return a one-time use access code for a real-time web-based transaction. Similarly, access code with a limited validity period or other restrictions may be returned by the control server 20.

The control server software 22 is able to receive end-user payment information for a payment transaction (examples include PayPal, debit card, or credit card) from the access control software 14, process that payment transaction through an interested party system, and send back to the access control software 14 either an access code or a command authorizing access.

The control server software 22 is further able to track each operator's access code requests. Periodically, the control server 20 may generate a summary for each operator showing such operating data as the access code requests, the expected operator revenue, and the daily and cumulative billing charges. This summary may be sent to the operator by e-mail or other means. This summary may include the operator's authorization code for requesting access codes for the following day. Based on the disclosure and teachings provided herein, a person of ordinary skill in the art will appreciate other types of information that can be provided by the control server 20 to the operators in accordance with the present invention.

The control server software 22 is capable of generating a bill for each billing period (e.g., on a monthly basis), and takes appropriate actions with a financial institution (e.g., charging a credit card, debiting a prepaid balance, charging a PayPal account, or generating an electronic or paper bill).

The control server software 22 is able to deactivate the access control software 14 associated with delinquent operators, and detect and prevent attempts to re-activate any deactivated access control software 14.

The control server software 22 is capable of exercising oversight of access code requests in order to alert operators to possible instances of operator fraud and abuse. The access control software 14 may send usage information to the control server software 22 as it would to a RADIUS server. The control server software 22 would then reconcile the usage information with the access code requests. This permits the control server software 22 to flag a higher number of possible fraud conditions, as well as generate more complete information for management and analysis.

The access control software 14 (in the embodiment shown in FIG. 1) or the control server software 22 (in the embodiment shown in FIG. 2) allows the operator to define a number of “products” that the operator wishes to promote and offer for sale via the access point 12. For example, simple alphanumeric codes representing the products might be used such as “T30” representing “30 minutes of connect time, priced at $1.00.” The usage parameters and/or business rules instruct the access control software 14 on how to interpret access codes.

The access code allows the access control software 14 to authenticate the client 18 based on a proprietary or other well known authentication algorithm. The access code serves to inform the access control software 14 algorithmically which “product” the client 18 has purchased. The following are some of the rules to be observed in access code creation and interpretation: (a) access codes are not to be reused for the same operator; (b) access codes are only valid for a limited, predefined period of time; (c) no more than one communication session or connection per access code; (d) access codes are valid only for the issuing operator.

It should be understood that the present invention as described above can be implemented using software, hardware or a combination of both, in a distributed or integrated manner. Based on the disclosure and teachings provided herein, a person of ordinary skill in the art will appreciate other ways and/or methods that can be used to implement the present invention.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference for all purposes in their entirety.

What is claimed is:

1. A system for managing local control of access to a computer network, comprising:
an access point having an operating system and access control software;
wherein the access control software is configured to receive an access code from a client and authenticate the client using the access code;
wherein the operating system is configured to allow a communication session to be established between the client and the computer network upon the client being successfully authenticated by the access control software; and
wherein the access control software is further configured to meter and rate the communication session.

2. The system of claim 1 wherein the access point is further configured to manage access with respect to one or more communication sessions.

3. The system of claim 1 wherein one or more methods are available for use by the access control software to meter and rate the communication session.

4. The system of claim 3 wherein one of the one or more methods uses information from a website being visited to meter and rate the communication session.

5. The system of claim 3 wherein the access control software uses information specified by an operator of the access point to select at least one of the one or more methods to be used to meter and rate the communication session.

6. The system of claim 3 wherein the access control software selects at least one of the one or more methods to be used to meter and rate the communication session by using information associated with the access code.

7. The system of claim 1 wherein the access control software is further configured to meter and rate the communication session in real time.

8. The system of claim 1 wherein one or more access codes are generated based on the information specified by an operator.

9. The system of claim 1 wherein the access control software is capable of being activated by the operator.

10. The system of claim 1 wherein the access control software is further configured to terminate the communication session between the client and the computer network when a usage limit is reached.

11. The system of claim 10 wherein the access control software is further configured to inform the client when the client approaches the usage limit for the communication session.

12. The system of claim 5 wherein the information specified by the operator includes parameters governing usage and access conditions for the access point.

13. The system of claim 12 wherein information associated with the access code includes at least one of the parameters governing usage and access conditions for the access point.

14. The system of claim 12 wherein the parameters include at least one of maximum session time, maximum data volume, the one or more methods that are available to meter and rate the communication session and access conditions including time period restrictions and restrictions on number of clients.

15. The system of claim 1 further comprising:
a control server having control server software, wherein the control server is configured to communicate with the access point.

16. The system of claim 15 wherein one or more access codes are generated by the control server software and forwarded to the access point.

17. The system of claim 15 wherein the control server is further configured to communicate with one or more access points.

18. The system of claim 15 wherein the control server software is further configured to carry out a process to initialize an account for an operator of the access point.

19. The system of claim 18 wherein during the account initialization process, either the operator or the access control software or both provide information including identification information and billing information to the control server software.

20. The system of claim 18 wherein either the operator or the access control software or both provide information to the control server software that is to be used by the access control software to meter and rate one or more communication sessions.

21. The system of claim 20 wherein the control server software allows the operator to change the specified information.

22. The system of claim 20 wherein the control server software is further configured to generate one or more access codes using the information specified by the operator.

23. The system of claim 8 wherein at least one of the one or more access codes is subject to one or more restrictions.

24. The system of claim 23 wherein the one or more restrictions include a one-time use.

25. The system of claim 15 wherein the control server software is further configured to process end-user payment information received from the access control software.

26. The system of claim 15 wherein the control server software is further configured to receive one or more requests from the access control software to generate corresponding access codes.

27. The system of claim 26 wherein the control server software is further configured to track information relating to the one or more requests from the access control software and other activities incurred by the access point.

28. The system of claim 27 wherein the control server software is further configured to report the tracked information to the operator.

29. The system of claim 27 wherein the control server software is further configured to generate a bill to the operator based on the tracked information.

30. The system of claim 1 wherein the access point is a router.

31. The system of claim 1 wherein the access code is provided to the access point by the client via wireless communications.

32. A system for managing local control of access to a computer network, comprising:
a plurality of access points, each access point configured to receive a plurality of access codes from a plurality of clients and authenticate the plurality of clients using the corresponding access codes, each access point further configured to provide a service to a client based on the client's corresponding access code, the service including establishing a communication session between the client and the computer network upon the client being successfully authenticated by the access point; and
a control server configured to communicate with the plurality of access points, the control server further configured to generate the corresponding access codes for the plurality of clients and forward the corresponding access codes to the plurality of access points.

33. The system of claim 32 wherein a first access point is further configured to meter and rate the communication session for the client using the client's access code.

34. The system of claim 33 wherein one or more methods are available for use by the first access point to meter and rate the communication session.

35. The system of claim 34 wherein one of the one or more methods uses information from a website being visited to meter and rate the communication session.

36. The system of claim 34 wherein the first access point uses information associated with the client's access code to select at least one of the one or more methods to be used to meter and rate the communication session.

37. The system of claim 33 wherein the control server generates one or more access codes for the client seeking access via the first access point based on information specified by an operator of the first access point.

38. The system of claim 37 wherein the information specified by the operator includes parameters governing usage and access conditions for the first access point.

39. The system of claim 38 wherein information associated with at least one of the one or more access codes for the client includes at least one of the parameters governing usage and access conditions for the first access point.

40. The system of claim 38 wherein the parameters include at least one of maximum session time, maximum data volume, one or more methods that are available to meter and rate the communication session and access conditions including time period restrictions and restrictions on number of clients.

41. The system of claim 33 wherein the first access point is further configured to meter and rate the communication session for the client in real time.

42. The system of claim 33 wherein the first access point is further configured to terminate the communication session between the client and the computer network when a usage limit is reached.

43. The system of claim 33 wherein the first access point is further configured to inform the client when the client approaches the usage limit for the communication session.

44. The system of claim 32 wherein the control server is further configured to carry out a process to initialize an account for an operator of a first access point.

45. The system of claim 44 wherein during the account initialization process, either the operator or the first access point or both provide information including identification and billing information to the control server.

46. The system of claim 44 wherein either the operator or the first access point or both provide information to the control server, the information provided to the control server is to be used to provide the service including metering and rating the communication session.

47. The system of claim 46 wherein the control server allows the operator to change the specified information.

48. The system of claim 46 wherein the control server is further configured to generate one or more access codes for a client using the information specified by the operator.

49. The system of claim 32 wherein at least one of the plurality of access codes is subject to one or more restrictions.

50. The system of claim 49 wherein the one or more restrictions include a one-time use.

51. The system of claim 32 wherein the control server is further configured to process end-user payment information received from one or more of the plurality of access points.

52. The system of claim 32 wherein the control server is further configured to receive a plurality of requests from the plurality of access points to generate corresponding access codes.

53. The system of claim 52 wherein the control server is further configured to track information relating to the plurality of requests from the plurality of access points and other activities incurred by the plurality of access points.

54. The system of claim 53 wherein the control server is further configured to report the tracked information to corresponding operators of the plurality of access points.

55. The system of claim 53 wherein the control server is further configured to generate bills to corresponding operators of the plurality of access points based on the tracked information.

56. The system of claim 32 wherein the plurality of access points include a router.

57. The system of claim 32 wherein at least one of the plurality of access points communicates with the plurality of clients via wireless communications.
